(19) United States
(12) Patent Application Publication
(10) Pub. No.: US 2006/0077969 A1
(43) Pub. Date: Apr. 13, 2006

(54) Communication method with push-to-talk functionality

(75) Inventors: Marian Trinkel, Kreuzau OT Untermaubach (DE); Christel Mueller, Schulzendorf (DE); Frank Daussmann, Hassloch (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Deutsche Telekom AG, Bonn (DE)

(21) Appl. No.: 11/248,094

(22) Filed: Oct. 12, 2005

(30) Foreign Application Priority Data
Oct. 12, 2004 (DE) DE 10 2004 049 56

(51) Int. Cl. H04L 12/66

(52) U.S. Cl. 370/352

(57) ABSTRACT

A method for performing a communication over at least one telecommunications network includes sending a communication from a sending telecommunication device. At least one receiving telecommunication device is selected based on an identifier of the sending telecommunication device.

Priority is claimed to German patent application DE 10 2004 049 561.0, the entire subject matter of which is hereby incorporated by reference herein.

The present invention relates to a method for performing a communication, in particular a voice communication, over at least one telecommunications network between a sending communication device and at least one receiving telecommunication device. The present invention also relates to a system for performing such a communication.

### BACKGROUND

In mobile communications technology, voice communication between at least one sending telecommunication device and at least one, in particular a plurality of simultaneously receiving telecommunication devices is known by the term “push-to-talk functionality”. This functionality can be used with mobile radio telephones specifically designed for this purpose and means basically that a telecommunications user can simultaneously communicate with a plurality of other telecommunications users after pressing a corresponding push-to-talk key, or in short, a PTT key. In this connection, however, only one person within a defined closed group of telecommunications users is able to speak at a time, but never a plurality of persons at the same time. This is therefore a half-duplex method.

In this known push-to-talk functionality, all telecommunication devices of the closed user group are in permanent telecommunications connection, for example, over the GSM network of a mobile operator; the actual communication, i.e., voice transmission, taking place in a packet-based manner, for example, using the GPRS standard, and the voice then being transmitted during the existing communication connection by sending GPRS packets. To this end, the user of a mobile telephone presses the so-called PTT key, causing a central server to open the voice channel for said user (unless this was previously done for a different user), said voice channel remaining reserved as long as the key is pressed. During this period, only the person who has pressed the PTT key is able to speak while the other group members can only listen.

This method has the disadvantage that a permanent communication connection must exist over the GSM network of a mobile operator, and, moreover, that this method can only be carried out using mobile telephones specifically suited for this purpose.

It is also known in the prior art to use telephones of any kind to establish so-called “conference calls”, during which a plurality of communications users can speak and listen to each other at the same time. This method can, in fact, be carried out using any telephone; but here too, a permanent communication connection must exist, that is, a user of a telephone can participate in the group communication only as long as his/her telecommunications connection to the group is active and maintained.

### SUMMARY OF THE INVENTION

An object of the present invention is to provide a method and system in which a communication with at least one, preferably a plurality of other telecommunications users can take place in a device-independent manner, that is, using any telecommunication device available, without the need for a telecommunications connection to be permanently maintained.

The present invention provides a method for performing a communication, in particular a voice communication, over at least one telecommunications network between a sending telecommunication device and at least one receiving telecommunication device. The method includes selecting the receiving telecommunication device(s), in particular a group of receiving telecommunication devices, based on an identifier of the sending telecommunication device.

Such an identifier is preferably intended to identify the telecommunication device or its user, for example, in the telecommunications network. For example, such an identifier may be the network identifier of the telecommunication device, i.e., for example, the subscriber telephone number (CLI: Call Line Identity) of landline telephones, the Home Location Register (HLR) of mobile telephones, a device identifier such as the 15-digit IMEI (International Mobile Equipment Identity), the card identifier of a SIM card (for example, of mobile telephones), or also biometric identifiers of a user, such as fingerprint, voice, etc.

The method according to the present invention provides a push-to-talk-like functionality in a purely network-based form without the need for the respective telecommunication devices to be particularly suited for this purpose.

Accordingly, provision can be made that a network-based service for carrying out this communication according to the present invention be started by calling a special network identifier, such as a telephone number.

In this connection, the type of the telecommunication device used is irrelevant because any telecommunication device hooked up to a network has a network identifier/device identifier and possibly further identifiers. The identifier in question may be the so-called “Call Line Identity” (CLI) of a landline telephone, in a mobile telephone mainly the so-called “Home Location Register” (HLR), or the permanently or temporarily assigned IP address of an Internet-capable computer.

In carrying out the method of the present invention, a network-based service is started by calling a special network identifier, i.e., that this service is not permanently maintained between all users.

In this connection, it is perceived as being advantageous if the network identifier which is to be called and which, when called, starts the service, is stored under a key of the sending telecommunication device. This key can essentially be any key of the particular device, such as a key of the keypad usually provided, or a separately provided special function key. In this manner, the user of a telecommunication device is given the impression of invoking a PTT-like function simply by pressing the key, said function allowing communication with at least one other communications user, preferably with a plurality of communications users.

In the telecommunications network, in particular, in the switching center, at least one receiving telecommunication device is advantageously selected as a function of an identifier of a sending telecommunication device, which, in particular, is transmitted to the network. For example, the network identifiers of receiving telecommunication devices may be maintained in a list internal to the network.

This means, for example, that when calling the service-starting network identifier, a message is sent to all telecommunication devices whose network identifiers are stored in a list.

This does not necessarily require a connection to exist to all telecommunication devices at the same time. Instead, a message, for example, a voice message, may initially be stored within the network, and subsequently be sent to all telecommunication devices specified in the receiver list, so that each of the telecommunication devices intended for reception receives the particular message, for example, a voice message. In case a telecommunication device selected in this manner may not be ready to receive, a message may also be stored and maintained for retrieval at a later time.

Furthermore, a preferred embodiment may provide for at least one or a plurality of receiving telecommunication devices to be selected in the telecommunications network, in particular, in the switching center, as a function of a parameter. This parameter can, in principle, be any parameter that is given in the network or provided by the user. Accordingly, in addition to an identifier, such as the network identifier of the sending telecommunication device, it is possible to add further parameters, such as, for example, the network identifier of a called telecommunication device, for example, the network identifier of a service server used to start the service of the present invention, or one of the above-mentioned alternative identifiers, which is then used as an additional parameter.

Thus, it is possible to provide a plurality of service-starting network identifiers, the method of the present invention being carried out in each case, but with different telecommunication devices intended for reception and specified in this manner.

Thus, for example, within the telecommunications network, there may exist a plurality of selectable lists in each of which are stored groups of network identifiers of telecommunication devices intended for reception; it being possible to select a list and the identifiers contained therein via a suitably transmitted parameter. In this connection, it may also be possible for the user who operates a sending telecommunication device to make a parameter entry for this selection on the keypad of the device.

Preferably, the at least one receiving telecommunication device, or, in particular, a group of receiving telecommunication devices, can be determinable by the user of the sending telecommunication device, for example, by said user entering the respective network identifiers of the receiving telecommunication devices into at least one list. Accordingly, such a list can be administered by the user and may preferably be selected by the identifier and/or a parameter.

Similarly, in another embodiment, the at least one receiving telecommunication device may be determinable by the network operator, in which case, agains, the respective network identifiers may be maintained in a list. However, this is not absolutely necessary.

This allows, for example, for a network-based function which, after a message or pure data to be communicated to one or more users is dispatched by the sending telecommunication device, sends said message or data to all telecommunication devices located within a certain area around the sending device.

This is particularly simple to implement because, due to the dispatching procedure on the part of the sending telecommunication device, the identifier, in particular, the network identifier of said device is known, which makes it possible to locate the sending device. Thus, through suitable verification within the network, for example, in a switching center, it is then possible to detect telecommunication devices that are ready to receive and located within a certain area around the sending device, so as to then establish the message and/or data communication to these telecommunication devices.

In the context of the present invention, the communication can generally be pure data communication only between the involved devices, or a communication of the users who operate the devices at any one time, for example, by voice transmission.

In addition to the respective participating telecommunication devices being specified by the user, for example, in a list, or by the telecommunications network, for example, as described above, parameterized by the spatial position of the sending device, it is also conceivable to use any other parameters for selecting the receiving telecommunication devices as a function thereof. These parameters may either be available to the network, or be explicitly provided to the network, for example, by the user, such as also biometric data.

In accordance with the present invention, the message or data to be sent may be sent from a telecommunication device to a telecommunications network and thus arrive, for example, at a switching center. According to the present invention, the sent data may then be transmitted to the receiving telecommunication devices over the same network, as is the case in common communications. This may be the case, for example, for telephone call-like voice messages.

In another preferred embodiment of the method according to the present invention, the network receiving a message or data to be communicated from a sending telecommunication device may be a network other than that used for sending the message or data to the receiving telecommunication devices.

In this connection, the transmission network can, for example, be a one-way broadcasting network.

In the context of the present invention, it is therefore conceivable that a message to be sent is dispatched by a user over the common telecommunications network intended for this purpose, using a telecommunication device, but that this message is then broadcast over a broadcasting network, possibly encrypted in such a way that only the telecommunication devices intended for reception are able to receive the message then broadcast.

For this purpose, telecommunication devices may have a suitable receiver section for such broadcast transmissions. Usually, however, reception will be possible with the standard receiver sections provided in telecommunication devices, especially if the devices used are mobile telephones.

If the user of a receiving telecommunication device from the group of devices intended for reception then wishes to respond to the received message, it is possible for said user to dispatch a corresponding call, again by pressing the key provided for this purpose, or to dispatch a message by calling the service-starting network identifier; this message reaching all users that are stored in the group of the then sending communication device or which are maintained (centrally or in a distributed manner) in a provided file. To this end, it is preferred that the same network identifiers participating in a group be stored in all telecommunication devices participating in the group or behind the respective identifying (network) identifiers. This guarantees message exchange between all users.

Moreover, in a refinement of the method, a communication connection between a sending telecommunication device and a receiving telecommunication device may be converted into a communication between only these two users, for example, into a normal telephone call.

This is an advantage when the intention is to exchange messages that concern only these two telecommunications users while preventing the other members of the group from receiving these messages. For this purpose, provision can be made for such a transformation into a normal telecommunications connection to be initiated by a parameter transfer to the telecommunications network. After conversion into a normal telephone call, these respective group members can then be deleted from the group, at least temporarily, i.e., for as long as they are making their telephone call.

In another or further embodiment, all users of telecommunication devices that are stored in a list of a telecommunication device/user initiating a group call may also be able to continue communicating with each other within the group, even if the first user no longer participates in the communication.

For example, it may be provided that all network identifiers of receiving telecommunication devices entered in a list and the network identifier of the calling telecommunication device are entered into the lists of all receiving telecommunication devices, so that, after a first initiating invocation of the function of the present invention, all other telecommunication devices determined by the telecommunication device calling for the first time receive identical lists (in particular, except for the respective own network identifier).

In a preferred embodiment according to the present invention, provision can be made to select a public telecommunication device located in a vicinity of a mobile telecommunication device. This can make it possible, for example, to use a mobile telephone to access the cheaper landline network instead of the mobile telecommunications network, for example, by selecting a public telephone booth.

This can be accomplished, for example, by starting a network-based service of the present invention using the mobile telecommunication device, said network-based service selecting at least one or all public telecommunication devices that are located in the vicinity of the mobile telecommunication device, which can be easily established, as above, by analyzing an identifier, in particuluar, the network identifier of the calling telecommunication device. Thus, it is possible to establish the location, and to select public telecommunication devices in the vicinity accordingly.

Then, the existing mobile communication in the network used for the call may be used to establish a communication connection to the public telecommunication device, from where the connection is then routed to a telecommunications network to which the public telecommunication device is connected.

This makes it possible, for example, to use a mobile telecommunications network only to the nearest public access point, and to then perform the communication over the landline network.

In a further refinement, it is also possible to disconnect the mobile telecommunications connection used for the service-starting call, and to establish a direct radio link between a mobile telecommunication device and the public telecommunication device selected.

Accordingly, with respect to a mobile telephone, the service can initially be started over the GSM mobile telecommunications network, whereby a nearest public telephone booth is selected as a function of the home location register information about the location of the mobile telephone, after which the actual mobile telephone connection to the GSM network is disconnected, and instead a direct radio link is established between the mobile telephone and the public telephone booth, for which purpose the latter may have to be suitably equipped. This requires that the radio link have an appropriate transmission range, which, however, can be guaranteed if the information about the locations of the both telecommunication devices is known to the network that initially makes the connection.

This makes it possible to get radio access via radio to the landline network via a radio link initiated by the method of the present invention, which may then result in telephone charges other than those in the respective mobile telecommunications network in question. This, in turn, also opens new opportunities for the use of public telecommunication devices, such as telephone booths.

In this connection, it is perceived as being advantageous that a public telephone booth can be used after previously executing the method according to the present invention without said telephone booth having to have any special equipment needed for communication, such as a wired handset, in particular, a receiver, or also a keypad. Ultimately, the mobile telephone acts here as a handset for a public telephone booth, which also makes it possible to put an end to vandalism, and makes the use of a public telephone booth more hygienic.

Furthermore, a particular advantage results from the fact that one and the same public telephone booth may be used by a plurality of users at the same time, as the case may be, for which purpose, for example, a radio link exists between the mobile telephone of each user and the public telephone booth, said radio link then connecting the call of each of the plurality of users to the landline network.

Accordingly, a further advantage is that waiting lines in front of public telephone booths, or publicly accessible telecommunication devices in general, can be reduced, or even prevented from occurring. Accordingly, any user who has a mobile telecommunication device and is located in the vicinity of a public telecommunication device can use this device to get access to a different network.

Independently of the above-illustrated example between a mobile telephone and a public telephone booth, the concept of the present invention can be extended to include telecommunication devices of other types. For example, it is also possible to use a computer having a telephone interface card to find the nearest public Internet access point, to which a connection, for example, a radio link, is then established in order to retrieve data from the Internet.

### BRIEF DESCRIPTION OF THE DRAWINGS

Exemplary embodiments of the present invention are shown in the drawings, in which:

FIG. 1 illustrates the use of the method of the present invention for fleet management; and

FIG. 2 illustrates the use of the method of the present invention for accessing the landline network via a public telephone booth.

### DETAILED DESCRIPTION

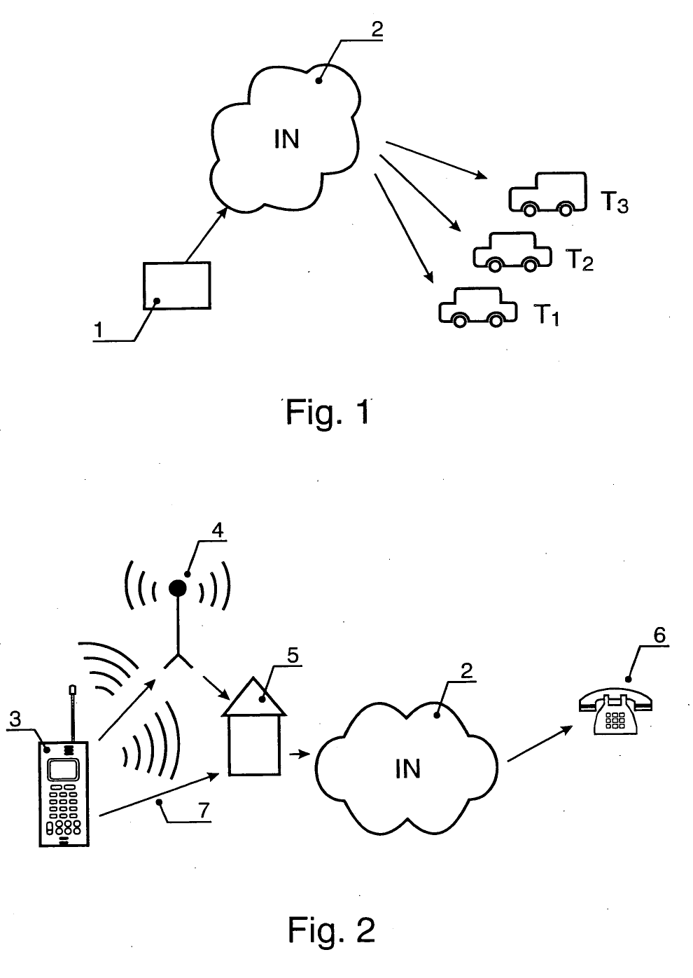

FIG. 1 exemplifies the method of the present invention in the framework of a fleet management system, such as may be useful, for example, for a taxi company. In this context, for example, a taxi service center 1 may call a special telephone number using a normal landline telephone and thereby reach a switching center in the intelligent network 2 of a network operator, where the call line identity, and thus, the network identifier of taxi service center 1, or a different identifier, are determined in response to the call. Based on this network identifier (CLI), it can be established in the intelligent network that the request for the group call comes from the taxi company, so that then all network identifiers, and thus, for example, telephone numbers of the taxi drivers moving in the vicinity, are selected in a suitable list set up by the taxi company. Thus, a request for information, for example, about which one of the drivers is able to accept a passenger, can be sent to all taxi drivers T1, T2 and T3 whose telephone numbers, and thus, network identifiers, are stored in the respective list.

Using the same method according to the present invention, each taxi driver can then affirm that he/she is ready to pick up the passenger, for which purpose the taxi driver also invokes the service of the present invention, but this time from his/her particular mobile telephone. In this manner, it is guaranteed that, for example, if taxi driver T1 answers the call, the service center and taxi drivers T2 and T3, which are then part of the receiving group of taxi driver T1, are simultaneously informed that this taxi driver will accept the passenger. After that, taxi drivers T2 and T3 do not need to answer anymore.

Another exemplary embodiment including a connecting telephone booth is illustrated in more detail in FIG. 2. For example, the user of a mobile telephone 3 can start the group call by calling a corresponding mobile telephone number; the GSM network initially using the reception of a corresponding mobile radio antenna 4 and a switching center reached in this manner to determine the location of the user of mobile telephone 3, which may be established using the home location register identifying the mobile radio cell. Then, a telephone booth 5 existing in the vicinity can be detected as a function of this information, i.e., as a function of the network identifier of mobile telephone 3. Accordingly, telephone booth 5 can be selected within the GSM network with respect to the present example.

Then, it is possible, on the one hand, to maintain the connection to telephone booth 5 using the GSM network, and to perform a landline communication from said telephone booth to intelligent network 2, and to reach the user of a landline telephone 6 in this manner.

It is also possible to establish a direct radio link 7 between mobile telephone 3 and public telephone booth 5. In this case, the communication connection over the GSM network can be disconnected.

Hence, mobile telephone 3 is used only as a wireless handset, in particular, receiver, for public telephone booth 5, via which the communication with any other user of a telecommunication device can then by established through connection to the intelligent network of a network operator.

Those skilled in the art will recognize that for performing this communication, in an embodiment of the method of the present invention constitutes at least a sub-step, in which the landline public telephone booths located in the vicinity are detected via the call into the GSM network, and the nearest one is selected as a function of the home location register.

In the process, data is initially exchanged only between the devices themselves, but not yet between the users of the telecommunication devices.

What is claimed is:

1. A method for performing a communication over at least one telecommunications network, the method comprising:
sending a communication using a sending telecommunication device; and
selecting at least one receiving telecommunication device based on an identifier of the sending telecommunication device.

2. The method as recited in claim 1 wherein the communication is a voice communication.

3. The method as recited in claim 1 wherein the identifier is at least one of a network identifier, a device identifier, a card identifier, and a user identifier.

4. The method as recited in claim 1 wherein the user identifier includes a biometric user identifier.

5. The method as recited in claim 1 wherein the selecting is performed in the telecommunications network and further comprising maintaining, in a list, a network identifier of the at least one receiving telecommunication device.

6. The method as recited in claim 5 wherein the selecting is performed in a switching center of the telecommunications network.

7. The method as recited in claim 1 wherein the selecting is performed in the telecommunications network as a function of a network identifier of a called telecommunication device.

8. The method as recited in claim 7 wherein the selecting is performed in a switching center of the telecommunications network.

9. The method as recited in claim 7 wherein the selecting is performed using a plurality of selectable lists.

10. The method as recited in claim 1 further comprising determining the at least one receiving telecommunication device by a user of the sending telecommunication device.

11. The method as recited in claim 10 wherein the determining is performed by the user of the sending telecommunication device entering a network identifier of the at least one receiving telecommunication device into at least one list.

12. The method as recited in claim 1 further comprising determining the at least one receiving telecommunication device by a network operator.

13. The method as recited in claim 12 wherein the determining is performed by the network operator entering a network identifier of the at least one receiving telecommunication device into at least one list.

14. The method as recited in claim 1 further comprising:
storing, under a key of the sending telecommunication device, a network identifier; and
starting, by calling the network identifier, a network-based service for carrying out the communication.

15. The method as recited in claim 1 further comprising:
sending a message from the sending telecommunication device to the at least one receiving telecommunication device using a first network;
receiving the message using a second network.

16. The method as recited in claim 15 wherein the first network includes a one-way broadcasting network.

17. The method as recited in claim 1 further comprising converting a communication connection between the sending telecommunication device and the at least one receiving telecommunication device into a normal telephone call.

18. The method as recited in claim 1 wherein the sending telecommunication device includes a mobile telecommunication device, and the at least one receiving telecommunication device includes a public telecommunication device located in a vicinity of the mobile telecommunication device.

19. The method as recited in claim 18 further comprising performing a radio-based communication between the mobile telecommunication device and the public telecommunication device after the selecting.

20. The method as recited in claim 19 further comprising using the public telecommunication device as an access point, for the mobile telecommunication device, to a landline network.

21. The method as recited in claim 20 wherein the public telecommunication device includes a telephone booth and the mobile telecommunication device includes a mobile telephone.

22. The method as recited in claim 20 further comprising disconnecting a mobile telecommunications connection and establishing a direct radio link between the mobile telecommunication device and the public telecommunication device.

23. The method as recited in claim 1 wherein the at least one receiving telecommunication device includes a group of receiving telecommunication devices.

24. A system for performing a communication comprising:
a sending communication device;
at least one receiving telecommunication device; and
at least one telecommunications network configured to select the at least one receiving telecommunication device based on a network identifier of the sending telecommunication device.
